(19) United States
(12) Patent Application Publication
(10) Pub. No.: US 2019/0341244 A1
(43) Pub. Date: Nov. 7, 2019

(54) MULTI-CELL EXCIMER LAMP

(71) Applicant: Silanna UV Technologies Pte Ltd, Singapore (SG)

(72) Inventor: Norbert Krause, Hawthorne, QLD (AU)

(73) Assignee: Silanna UV Technologies Pte Ltd, Singapore (SG)

(21) Appl. No.: 16/343,985

(22) PCT Filed: Oct. 27, 2017
(86) PCT No.: PCT/IB2017/056697

§ 371 Date: Apr. 22, 2019

Related U.S. Application Data
(60) Provisional application No. 62/417,689, filed on Nov. 4, 2016.

(51) Int. Cl. H01J 65/04; H01J 61/30; H01J 61/36; H01J 9/24

(52) U.S. Cl. CPC H01J 65/046; H01J 9/247; H01J 61/361; H01J 61/30

(57) ABSTRACT

An excimer lamp includes a plurality of sheets and a plurality of spacers arranged to form a stack of a plurality of cells in comprising a plurality of chambers. The plurality of sheets includes a first outer sheet, a second outer sheet and a plurality of interior sheets. Each sheet in the plurality of sheets has an outer edge and comprises a material that is transmissive to a target wavelength. Each spacer is placed between two sheets and near the outer edge of each sheet. Each chamber is defined by a volume at least partially enclosed by the two sheets and at least one spacer. An emission material is within each chamber. A first electrode is coupled to the first outer sheet, exterior to the stack, and a second electrode is coupled to the second outer sheet, exterior to the stack. A method of manufacturing the excimer lamp is also disclosed.

### RELATED APPLICATIONS

This application claims priority to U.S. Provisional Patent Application No. 62/417,689, filed on Nov. 4, 2016 and entitled “Multi-Cell Excimer Lamp”; the contents of which are hereby incorporated by reference for all purposes.

### BACKGROUND

Dielectric barrier discharge (DBD) excimer lamps are defined by a dielectric barrier located between two electrodes. The dielectric barrier borders a discharge volume that is usually hermetically sealed and includes a working gas that will be used to produce light. When sufficient potential builds up across the gas, an electrical discharge occurs between the two electrodes. The electrical discharge often takes the form of discharging filaments where each filament is a column of conducting plasma. The plasma comprises molecules or atoms of the working gas that have been excited or ionized via excitation of their composite electrons. Light is produced as the excited gas atoms or molecules fall back to a lower energy state.

DBD lamps can be used to produce narrow spectrum light. As a specific example, a DBD lamp can be designed to produce vacuum ultraviolet (VUV) light at 172 nm where the working gas is Xenon. The emission of a DBD is generally more diffuse and efficient when a pulsed excitation is used with sharp rise and fall times. However, this typically requires an expensive power supply and an electrically matched lamp-power-supply system which narrows the potential applications of the DBD lamp and adds cost and complexity to the overall system in which the DBD lamp will operate. Also, the introduction of pulsed power supplies into an environment introduces radio frequency (RF) noise which makes electrically isolating the RF noise a critical concern. A traditional sinusoidal driving scheme is potentially cheaper to build and has less complications, but delivers filamentary discharges and inefficient light emission.

### SUMMARY

In some embodiments, an excimer lamp includes a plurality of sheets and a plurality of spacers. The plurality of sheets includes a first outer sheet, a second outer sheet and a plurality of interior sheets. Each sheet in the plurality of sheets has an outer edge and includes a material that is transmissive to a target wavelength. Each spacer in the plurality of spacers is placed between two sheets in the plurality of sheets and near the outer edge of each sheet. The plurality of sheets and the plurality of spacers are arranged to form a stack of a plurality of cells including a plurality of chambers, each chamber being a volume at least partially enclosed by the two sheets and at least one spacer in the plurality of spacers. The excimer lamp also includes an emission material within each chamber in the plurality of chambers; a first electrode coupled to the first outer sheet, exterior to the stack; and a second electrode coupled to the second outer sheet, exterior to the stack.

In some embodiments, a method of manufacturing an excimer lamp includes providing a plurality of sheets. The plurality of sheets has a first outer sheet, a second outer sheet and a plurality of interior sheets, where each sheet in the plurality of sheets has an outer edge and comprises a material that is transmissive to a target wavelength. The method also involves sealing the first outer sheet to an adjacent lamp component, and stacking a plurality of spacers in an alternating arrangement with the plurality of sheets. Each spacer in the plurality of spacers is placed between two sheets in the plurality of sheets and near the outer edge of each sheet. The plurality of sheets and plurality of spacers are arranged to form a stack of a plurality of cells including a plurality of chambers, each chamber being a volume at least partially enclosed by the two sheets and at least one spacer in the plurality of spacers. The method further includes filling the plurality of chambers with an emission material; sealing the second outer sheet to the stack; coupling a first electrode to an outer surface of the first outer sheet; and coupling a second electrode to an outer surface of the second outer sheet.

### BRIEF DESCRIPTION OF THE DRAWINGS

FIG. 1 illustrates a plan view of inhomogeneous optical emission from a conventional dielectric barrier discharge (DBD) lamp.

FIG. 2 illustrates a vertical cross-sectional view of a multi-cell excimer lamp in accordance with embodiments of the present disclosure.

FIG. 3 shows an example light output from a multi-cell excimer lamp, in accordance with embodiments of the present disclosure.

FIG. 4 illustrates a vertical cross-sectional view of a multi-cell excimer lamp having an intermediate electrode, in accordance with embodiments of the present disclosure.

FIG. 5 shows a vertical cross-sectional view of another embodiment of a multi-cell excimer lamp having an intermediate electrode, in accordance with the present disclosure.

FIG. 6 is a table of example emission materials that may be used with the excimer lamps of the present disclosure.

FIG. 7A is a vertical cross-sectional view of an embodiment of a multi-cell excimer lamp including a frame, in accordance with embodiments of the present disclosure.

FIG. 7B is a top view of the excimer lamp of FIG. 7A.

FIG. 8 is a detailed view of a portion of the excimer lamp of FIG. 7A.

FIG. 9 is another detailed view of the portion of the excimer lamp of FIG. 7A.

FIG. 10 is an example flow chart of a method for manufacturing a multi-cell excimer lamp in accordance with embodiments of the present disclosure.

FIG. 11 shows the detailed view of FIG. 8 in a partially assembled state.

FIG. 12 is a plan view of a spacer in accordance with embodiments of the present disclosure.

FIG. 13 is a perspective view of another method of assembling a multi-cell excimer lamp in accordance with embodiments of the present disclosure.

### DETAILED DESCRIPTION

Reference now will be made in detail to embodiments of the disclosed invention, one or more examples of which are illustrated in the accompanying drawings. Each example is provided by way of explanation of the present technology, not as a limitation of the present technology. In fact, it will be apparent to those skilled in the art that modifications and variations can be made in the present technology without departing from the scope thereof. For instance, features illustrated or described as part of one embodiment may be used with another embodiment to yield a still further embodiment. Thus, it is intended that the present subject matter covers all such modifications and variations within the scope of the appended claims and their equivalents.

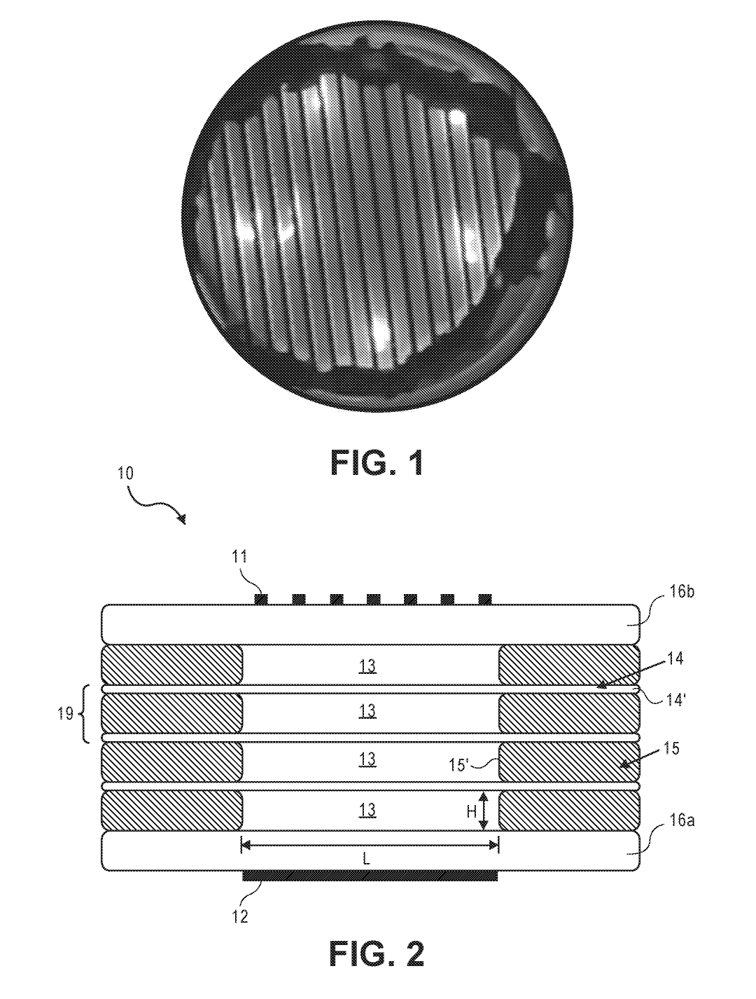

As mentioned above, dielectric barrier discharge lamps emit light via the formation of multiple filaments that form across the discharge volume. FIG. 1 illustrates a plan view of a conventional DBD lamp. As shown, the formation of filaments is inhomogeneous. The reason for this inhomogeneity is the erratic ignition of discharges in localized spots when the ignition condition for the discharge volume is met and subsequent surface charging in the vicinity of each discharge inhibits further discharges locally. An electron avalanche forms at that location which alters the electric field in its vicinity. This increased field collects charges from the surface of the insulator and funnels them towards one of the electrodes. The gas is locally exposed to the breakdown current, leading to a locally overheated gas while it is in other places not excited at all. Unfortunately, a homogenous excitation is desired from an efficiency perspective. Inhomogeneity is accompanied by inefficient filament formation in terms of the ability of the lamp to produce light in the desired spectrum. This is because electron—Xe collisions in the conducting plasma is not efficiently exciting the Xenon. In addition, if filaments favor a small subset of the overall surface area to the exclusion of others, a large fraction of the discharge volume will not produce light. Homogenous discharge is therefore important from both an efficiency standpoint and for the overall intensity of a given excimer lamp. In some lamp applications, the homogeneous emission across the lamp surface is also a requirement.

Inhomogeneous filament formation is caused by the stochastic rather than deterministic start of the electron avalanches that form the columns of plasma. The process becomes inhomogeneous due to residual charges on the dielectric surfaces that enhance the local electric field and pre-determine discharge locations. These residual charges are referred to as memory charges. The problems caused by memory charges can be self-perpetuating as certain portions of the discharge volume surface area are favored, and charge is more likely to build up, which causes filaments to favor formation in that area in the future. The use of a pulsed voltage source with sharp rise and fall times can combat this issue by rapidly releasing electrons across the entire surface area over a short time period. However, pulsed voltage sources can be costly compared to sinusoidal voltage sources.

In the present disclosure, a lamp is constructed of multiple cells that are aligned parallel with an outside electrode, and generates homogeneous light emission of high and very high intensity (e.g., >100 mW/cm² to >1000 mW/cm²). The cells are divided by thin layers of a transmissive material, and the lamp can be powered by a sinusoidal power supply. The embodiments herein enable a low cost excimer lamp. Approaches that prevent the formation of filaments in a DBD excimer lamp can allow for the use of inexpensive and simple power sources with slow rise and fall times as opposed to steep pulsed power sources. For example, even sinusoidal power sources can efficiently bias the discharge volume of a DBD excimer lamp that utilizes the disclosed approaches. However, these approaches can improve the operation of DBD excimer lamps generally, and would improve the performance of a DBD lamp regardless of the power source that is utilized.

Lamp Configurations

FIG. 2 shows a schematic vertical cross-section of an embodiment of an excimer lamp 10 having a top electrode 11, a bottom electrode 12, and multiple cells 19 forming chambers 13 between the electrodes 11 and 12. By using many thin cells instead of one thick cell as in conventional DBD lamps, the electron avalanches are stopped before they can form streamers and the resulting glow-like discharge is highly homogeneous. The lamp 10 may be square, circular or any other shape when viewed in plan view. The cells are created by sheets of transmissive material such as glass or sapphire sandwiched between spacers 15. A thicker sheet (16a, 16b) of transparent material is used for the outer layers of lamp 10, on which the electrodes 11 and 12 are mounted. Additional interior sheets 14 are placed within lamp 10, between spacers 15, to form the chambers 13. Thus, the excimer lamp 10 has a plurality of sheets including first outer sheet 16a, a second outer sheet 16b and a plurality of interior sheets 14. Each sheet in the plurality of sheets has an outer edge and comprises a material that is transmissive to a target wavelength. The target wavelength corresponds to the light that is desired to be produced, such as wavelengths in a range from 120 nm to 400 nm.

The sheets—including interior sheets 14 and outer sheets 16a, 16b—which delineate the discharge spaces or chambers 13 may be glass, sapphire or any other suitable vacuum ultraviolet/ultraviolet (VUV/UV) transmissive material. The sheets may be, for example, fused silica such as S313 by Heraeus or similar products from Corning. The sheets are typically made of high purity insulating material, and should be as thin as possible. Sapphire offers a very high mechanical robustness which allows for the use of very thin layers for the outer sheets 16a/16b when compared to glass. Also, the dielectric constant for sapphire is much higher (eps r=9 to 11) compared to glass (eps r=3.6). Both reduced thickness and higher eps r increases the light emission. However, glass may have a cost advantage and has a better transmission. Thus, the choice of sheet material may be chosen based on the design constraints for the particular lamp.

Four discharge spaces or chambers 13 are shown in FIG. 2, but in various embodiments the number of chambers 13 may vary as desired, such as two, six, or higher numbers of spaces. The chambers 13 may be on the order of, for example, 0.1 to 1.0 mm in height, such as 0.5 mm in some embodiments. Thus, in the embodiment of FIG. 2, if the four chambers 13 of lamp 10 are each about 0.5 mm high, the typical thickness of the lamp 10, including the sheets 14 and 16a/16b, is approximately 3 mm. The multi-cell design lends itself more towards smaller lamp areas such as on the order of 5 cm×5 cm square, to limit the amount of flexing in the thin glass sheets. However, larger lamps are possible by using suitable support structures throughout the lamp.

Spacers 15 may be, for example, ceramic or glass. The spacers 15 are placed between two sheets in the plurality of sheets (i.e., 14, 16a, 16b) and near the outer edge 14′ of each sheet. The plurality of sheets and plurality of spacers 15 are arranged to form a stack of a plurality of cells 19 having a plurality of chambers 13. Each chamber 13 is a volume at least partially enclosed by the two neighboring sheets and at least one spacer 15, and each chamber is filled with an emission material for generating the electrical discharge for emission of light. The spacer 15 may be configured with a gap in its perimeter that surrounds chamber 13, as shall be described in relation to FIG. 12, to allow for the filling of emission material into the chamber 13. For a circular lamp, the spacers 15 are annular. Similarly, for a square lamp the spacers 15 are configured as a square having a central opening. The central openings of the spacers 15 that define the chambers 13 are aligned with the apertured area of electrode 11 to allow the produced light to be transmitted through the lamp 10. In some embodiments, the chamber 13 may be enclosed by more than one spacer 15. For example, multiple spacers 15 configured as curved segments may be pieced together to form a complete ring-shaped spacer in a circular lamp. Similarly, multiple spacers 15 configured as linear segments may be used to form a square defining the chamber 13 in a square lamp. To prevent lateral emission of radiation, the vertical inner faces 15′ of the spacers 15 may be coated with a UV reflective surface. In one embodiment, the vertical inner faces 15′ may be coated with aluminum, as aluminum has high reflectivity in the VUV/UV ranges.

The cells 19 are thin and stacked parallel with each other. That is, the chambers 13 have high length-to-height aspect ratios on the order of, for example, at least 10, such as 20 or 50 or higher. However, smaller aspect ratios are not excluded from the embodiments of the present disclosure. In example embodiments of FIG. 2, the length L of chamber 13 may be 10-50 mm and the height H may be 0.1-1.0 mm. For a circular lamp, the length L represents a diameter, while for a square lamp the length L represents an edge-to-edge distance. The thinness of the cells 19 allows a large area for light to be produced across the length of the cell, while limiting the height so that filaments are prevented from forming. Thus, homogeneity of the light is improved.

The chosen dimensions of the lamp cells in the present disclosure generally depend on the pressure multiplied by the diameter of the lamp. For high pressure the tolerable cell height H is accordingly smaller, and vice versa. In practice, for a given gap (chamber height), it is desirable to increase the pressure to the maximum pressure where the lamp still emits homogeneously. The height of the cells also affects the operation of the lamp by impacting the capacitance. The capacitance of the lamp is in two states during operation: plasma on and off. When the plasma is on, the capacitance is defined by the thickness of all the dielectric between electrodes. When the plasma is off, the capacitance is defined by gas and dielectric between electrodes. The difference in capacitance (ΔC) between the two states times the voltage is the charge that is shifted back and forth, and this is directly correlated with the amount of electron-Xe (or other working gas) collisions and hence with the overall light emission. In order to maximize ΔC, all dielectric surfaces are ideally minimized. This is limited only by mechanical strength of the layer and its electric breakdown strength.

Continuing with FIG. 2, the top electrode 11 is coupled to outer sheet 16b, on an outer surface exterior to the stack of cells 19, and is in a plane parallel to the chambers 13 for generating the excitation energy within chambers 13 along with electrode 12. Top electrode 11 is illustrated as a mesh or grid in FIG. 2. However, in various embodiments the top electrode 11 may be configured as any type of apertured plate such as having square, slotted, circular openings or the like to allow UV radiation to escape from the lamp 10. The top electrode 11 may be made from aluminum, copper, or any suitable electrical conductor. The minimum thickness of the top electrode 11 determines voltage drop and losses and is dependent upon operating parameters.

The bottom electrode 12 reflects VUV/UV radiation and is illustrated as a solid plate in FIG. 2, but may be constructed to be aperture as per the top electrode 11. Bottom electrode 12 is coupled to outer sheet 16a, on an outer surface exterior to the stack of cells 19. Bottom electrode 12 may be made of, for example, aluminum, although any other metal or combinations of metals that achieves a suitable reflection and conductivity may be used. The minimum thickness determines voltage drop and losses and is dependent upon operating parameters of the lamp.

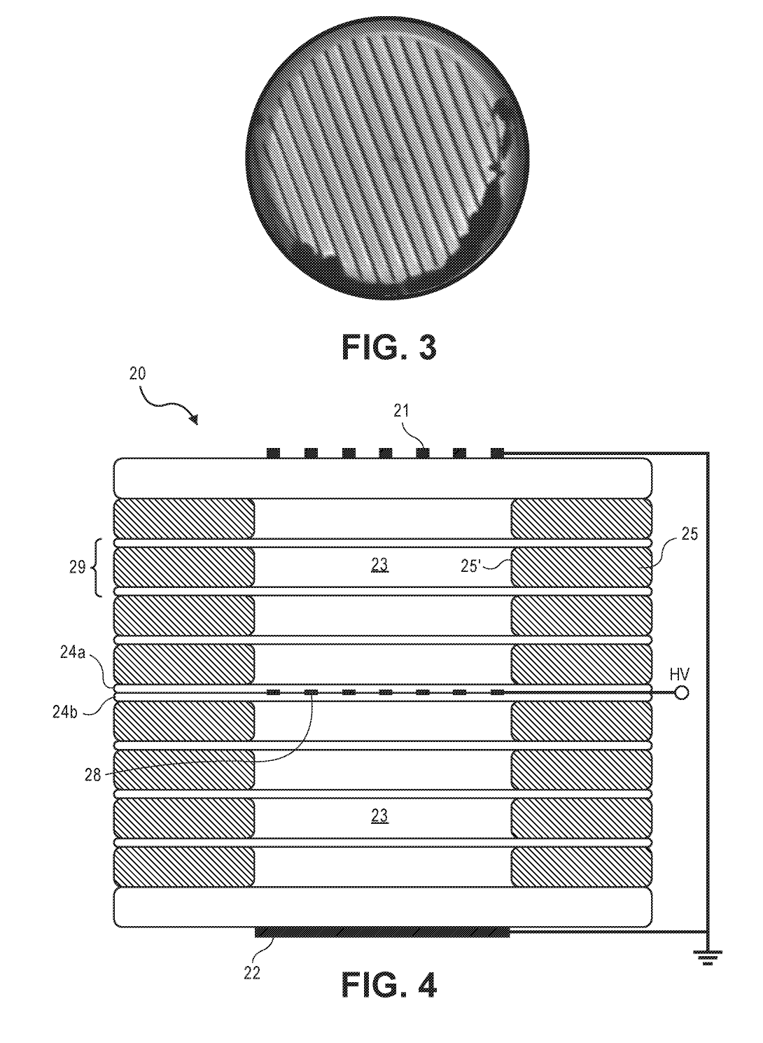

FIG. 3 is a top view photo of a sample multi-cell excimer lamp in operation, showing the homogeneity in optical emission. In the lamp of FIG. 3, the electrode (e.g., top electrode 11 of FIG. 2) has slotted apertures, and the chambers (e.g., chambers 13 of FIG. 2) have a circular horizontal cross-section. The lamp was configured with four chambers of 0.5 mm in height, 16 mm diameter with Xenon gas. A sapphire lid and 100 μm thick interior glass S313 sheets were used. In experimental trials, this sample lamp demonstrated 290 mW/cm² at 60 kPa and 120 kHz operated at 8000 V peak-to-peak and at 6.0% efficiency. For typical gas pressures of 0.1-1 atm in various sample lamps, the typical voltages (peak-to-peak) per layer was found to be approximately 1000-3000 V. Depending on the outer dielectric, a lamp of typically four cells at 60 kPa was typically operated at 8000 V (peak-to-peak). The measured VUV efficiencies were on the order of 6% and better. This lamp can typically generate >100 mW/cm² at 50 kHz. When driven at higher frequencies the VUV output intensity accordingly increases with the frequency, such as an estimated doubling at 100 kHz.

In the lamp of FIG. 3, a getter pump (actively heated) was used to increase the gas purity. Further increases are possible with a suitable transformer that allows frequencies above 120 kHz, as power increase appears to be linear with frequency. Additionally, further increases can be achieved by increasing the number of chambers along with voltage.

FIG. 3 shows that no filaments are formed, demonstrating the improved homogeneity of its discharge over conventional excimer lamps. The present embodiments therefore are similar to a conventional glow discharge but with a higher possible output power due to the optically serial built lamp. Additionally, the lamp is compatible with a sinusoidal power supply, as shall be described in more detail later. A conventionally built pulsed lamp could offer higher efficiency; however, the higher EMI noise is undesirable in many applications. Also pulsed power supplies are limited with regards to their repetition frequency, peak voltage and capacitive lamp load. A sinusoidal lamp has none of these restrictions and can achieve high output power.

FIG. 4 shows a schematic of a lamp 20 with further increased output intensity, and the corresponding electrical connection scheme. Lamp 20 has a top electrode 21, bottom electrode 22, and cells 29 with chambers 23 similar to FIG. 2. However, the embodiment of FIG. 4 also has a third, intermediate electrode 28 placed between sheets 24a and 24b within in the stack of chambers 23. In this embodiment, the intermediate electrode 28 is located halfway within the stack of cells 29, with four chambers 23 above electrode 28 and four chambers 23 below. The electrode 28 is illustrated as a mesh or grid in FIG. 4 in this embodiment; however, electrode 28 may be any plate with apertures as described in relation to electrode 11 of FIG. 2. The intermediate electrode 28 is connected to a high voltage source (HV), where the addition of electrode 28 provides additional energy to augment light production across the larger number of chambers compared to the 4-cell lamp 10 of FIG. 2. The electrode 28 is electrically connected such that the upper and lower halves of the lamp 20 operate in parallel to a high voltage source.

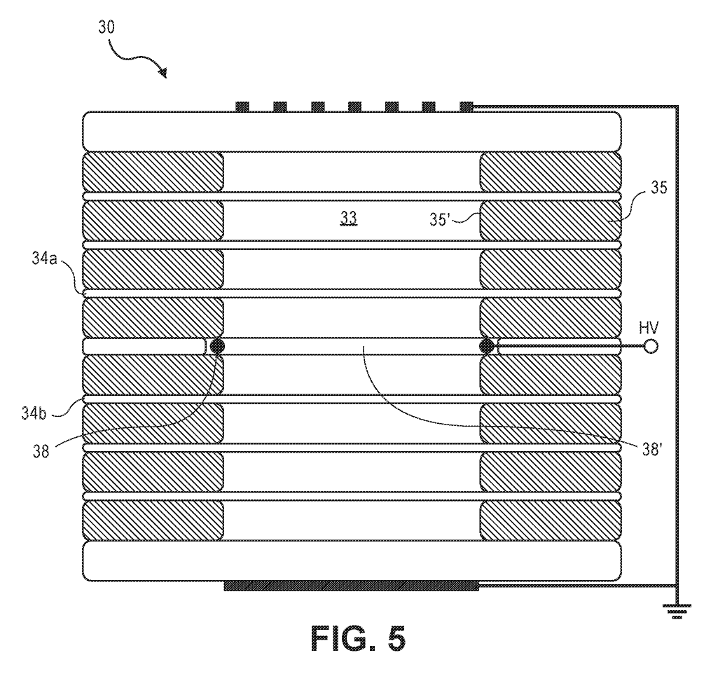

FIG. 5 shows yet another embodiment of a lamp 30 in which the intermediate electrode 38 is configured as a metal ring to serve as the electrical contact halfway inside the lamp 30. The intermediate ring electrode 38 allows an open region 38′ which eliminates the presence of a metallic grid (e.g., electrode 28 of FIG. 4) from absorbing radiation in the light production path through the chambers 33. A plasma streamer which would form from the ring electrode 38 to the surface of the nearest glass plates 34a and 34b would also contribute to the overall light emission.

In other embodiments, the output power may be increased by placing two or more of the presently disclosed lamps on top of each other or by adding further cells into a lamp. This is only limited by the maximum voltage constraints of the system and by the optical absorption from the thin glass sheets (or sapphire or other transmissive material).

In some embodiments, the vertical inner walls 25′ and 35′ of spacers 25 and 35 in FIGS. 4 and 5, respectively, may be coated with a reflective material such as aluminum, as described in relation to spacers 15 of FIG. 2. In some embodiments the chambers 13, 23 and 33 in FIGS. 2, 4 and 5 may be separate from one another or may be in fluid communication with other chambers or all chambers in the lamp. That is, each space may be sealed relative to the other spaces, or gas in each of the spaces may be free to travel from that space to other spaces in the lamp. For example, small holes may be provided in the sheets between the cells.

Although the principal lamp designs described above utilize many planar, parallel, thin sheets of glass enclosing gas, with the top and bottom electrode separated from the working gas by glass or another isolator, other ways may be used to achieve a sealed lamp design. For example, alternative constructions may be utilized for the way the thin glass sheets (or other transmissive sheet) inside the lamp are held. The sheets can be clamped, or remain floating being only loosely held by some spacers, notches or other means. For a floating glass, a small gap may be possible and should not affect the overall lamp performance. In other embodiments, it is possible to form small holes in the thin glass sheets to seed electrons vertically through the lamp. There are numerous methods to seal the lamp and design the lamp body for the purpose of sealing in the working gas with as low as possible leakage rate.

In various embodiments, the spacers or notches may be made of high purity insulators, such as the afore-mentioned S313 glass. In other embodiments, it is also possible to use metallic rings, or metallic rings covered with glass. Metallic rings offer reflectivity which assists in preserving radiation that might be otherwise lost by less reflective materials. In one embodiment, aluminum—which offers high reflectivity in the UV ranges—may be used as the material for the metallic rings. A glass coat on the aluminum (or other metal) would have the added benefit of reduced surface sputtering compared to making the entire ring out of metal.

Discharge Materials

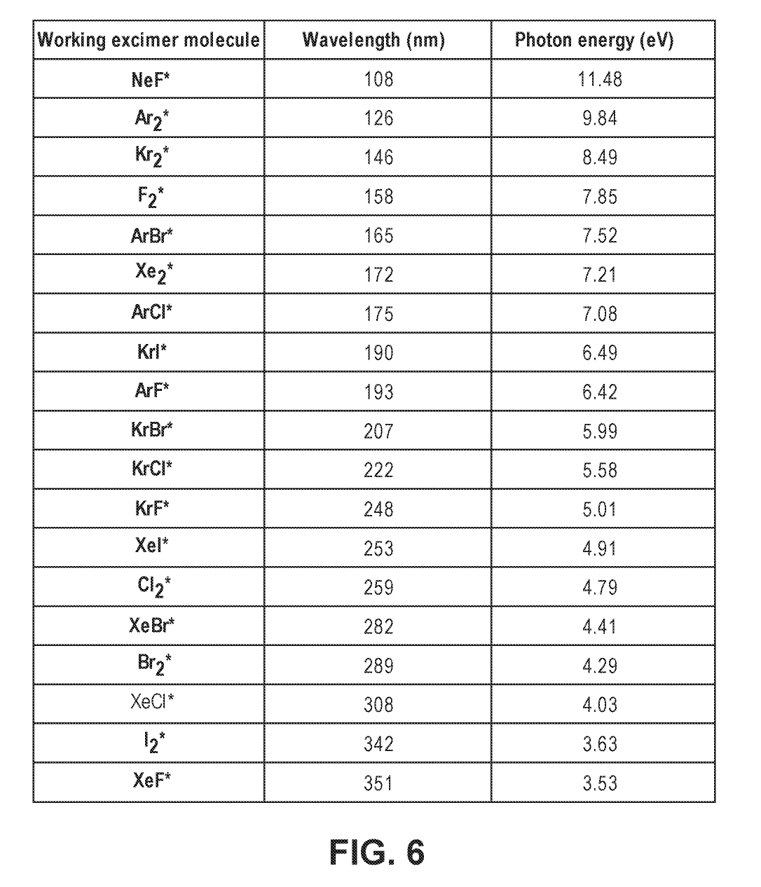

FIG. 6 provides a non-exhaustive list of possible emission materials, where the working excimer molecule is listed with a corresponding wavelength and photon energy. The VUV/UV emission wavelength produced by the lamps of the present disclosure is dependent upon the emission material used. Any suitable discharge substance may be used to achieve the desired wavelength, such as emission wavelengths between 120 nm to 400 nm. For example, for Xenon gas (Xe₂) the emission wavelength is centered at 172 nm. Gas mixtures can also be used to achieve other wavelengths, such as KrCl for 222 nm, XeI, KrF, XeBr, etc. The principal operation of the lamp will not change as a function of the gas in use. The gas and the gas pressure will determine the ideal gap size (i.e. height) of the chambers in the lamp. In some embodiments, the material does not need to be a gas and could be, for example, iodine that is vaporized. In some embodiments rare gas, or mixtures of halogen and/or rare gas could be used.

The emission material is under pressure, such as 100-1000 mBar (approx. 0.1 atm to 1 atm), for example 400-600 mBar. Ultimately, the pressure is dependent upon gap size between adjacent sheets in the cell, as there is a relationship between the gap size and pressure. Other pressures are not excluded, where higher pressures with smaller gaps are possible. The chosen pressure is determined based on trade-offs in the desired design parameters. A pressure that is too low can result in a thick lamp, which is more expensive to build. A pressure that is too high can increase the difficulty of sealing the lamp, as the gas pushes the lid off rather than having it passively supported by the frame for sub-atmosphere pressures. It also causes the relative thicknesses of the gas gap and dielectric to be similar, resulting in a negative impact on charge exchange (AC).

Lamp Construction and Sealing

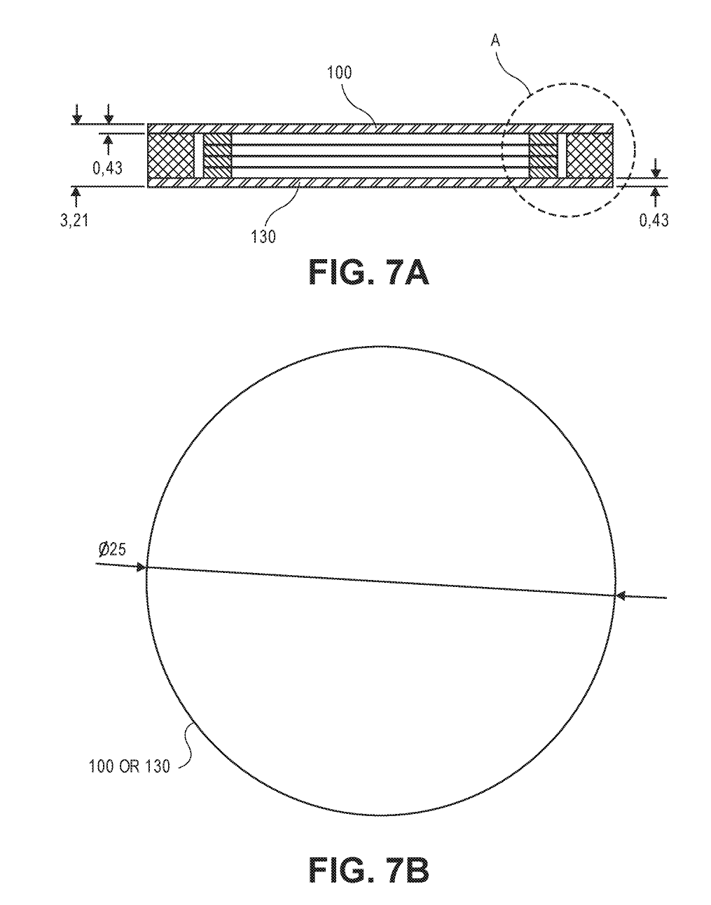

FIGS. 7-12 shall be used to describe details of manufacturing the lamps of the present disclosure, particularly regarding sealing of the chambers. FIG. 7A illustrates a vertical cross-section of an embodiment of a lamp with four cells and sheets of 0.1 mm thick S313 glass in the lamp cavity. The annotated dimensions are in millimeters, where the top outer sheet 100 and bottom outer sheet 130 are 0.43 mm thick and the total lamp height is 3.21 mm. FIG. 7B shows a plan view of the lamp where one of the outer glass sheets 100 or 130 is seen, having a diameter of 25 mm.

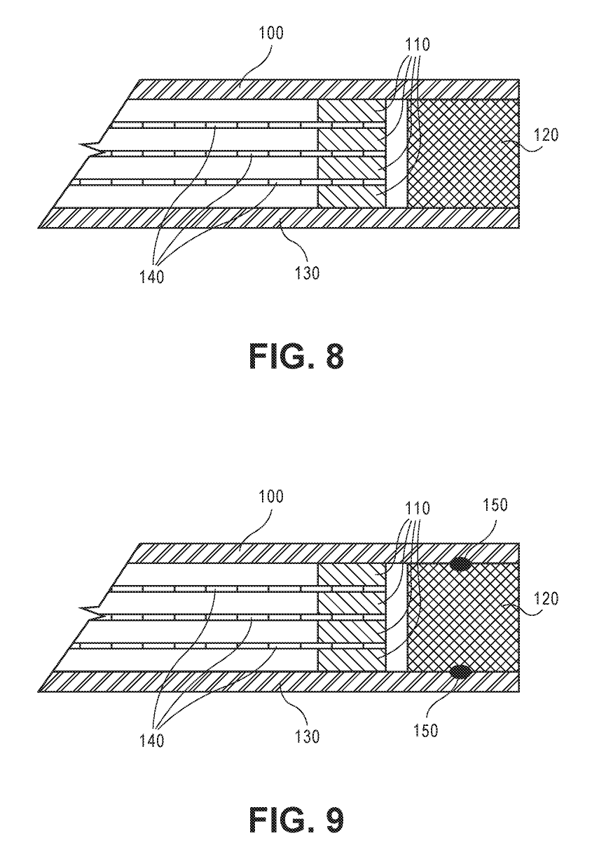

FIG. 8 is a close-up view of section A of FIG. 7A, showing further details of the lamp construction. Top outer sheet 100 is a sapphire or glass top surface, which is VUV transparent. Spacers 110 are ceramic or glass, and element 120 is a frame for the lamp. The frame 120 must be the same material as the outer sheets 100 and 130, e.g. glass or sapphire. Bottom outer sheet 130 is sapphire or glass, and internal sheets 140 within the lamp are thin glass or sapphire sheets. The electrodes of this lamp are not shown in FIG. 8 for clarity, but would be located on top of outer sheet 100 and below outer sheet 130; that is, on outer surfaces exterior to the stack of cells.

FIG. 9 is the same close-up view as FIG. 8, but with welding seam 150 shown in cross section. The welding is around the perimeter of the lamp—such as circumferential in the case of a circular lamp—and provides a hermetic seal between the upper surface of frame 120 and the top outer sheet 100, as well as between the lower surface of frame 120 and the bottom outer sheet 130. The welding may be achieved by a glass-to-glass or sapphire-to-sapphire hermetic laser welding process (such as performed by Primoceler Oy) in which a laser beam penetrates through the outer sheet 100 or 130, and focuses at the interface of the surfaces being welded. The pieces being welded together are pressed together during the welding, ensuring contact between the surfaces and resulting in a hermetic seal. This sealing capability enables lamps to be efficiently built with a gas lifetime fill. The sapphire or glass is welded in a clean atmosphere of the desired gas at the selected pressure, (e.g., Xenon at 40 kPa). Thus, the welding process offers the ability to seal the lamp with the desired gas enclosed inside the lamp.

The laser welding process may similarly be applied to the lamp configurations of FIGS. 2, 4 and 5 in which no frame is present. In other embodiments, the lamp may be sealed using methods other than laser welding, such as brazing (e.g., sapphire/metal/sapphire), soldering, gluing with epoxies, or compression fitting. In other embodiments, the lamp may be permanently connected to a gas source, rather than sealing it.

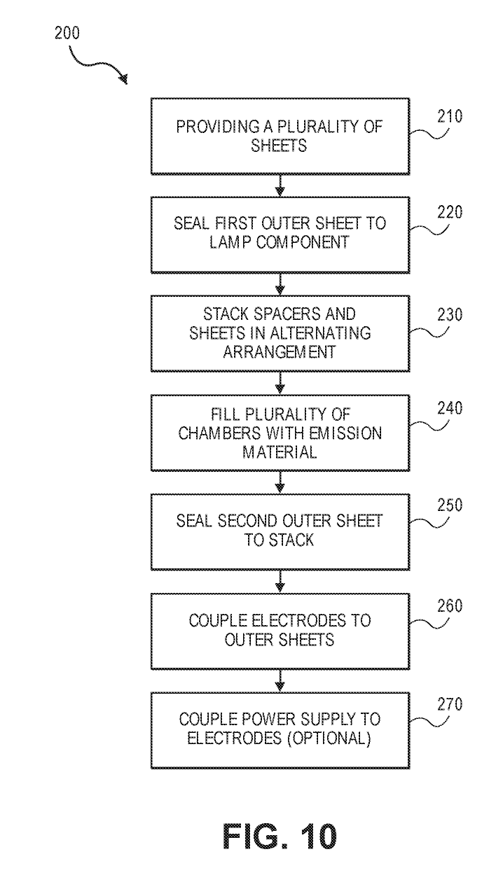

FIG. 10 is an example flow chart 200 of a method for manufacturing the excimer lamps of the present disclosure. The steps shall be described in relation to elements of FIGS. 9, 11 and 12. In step 210, a plurality of sheets is provided. The plurality of sheets includes a first outer sheet, a second outer sheet and a plurality of interior sheets. Each sheet in the plurality of sheets has an outer edge and comprises a material that is transmissive to a target wavelength. In step 220, the first outer sheet is sealed to an adjacent lamp component. For example, in embodiments that include a frame, the adjacent lamp component is frame 120 that is sealed to bottom outer sheet 130. In other embodiments, the adjacent lamp component may be spacer 110. The sealing may be performed by, for example, laser welding as described above.

Next, the plurality of spacers 110 and plurality of sheets 140 are assembled and stacked in an alternating arrangement in step 230. Each spacer in the plurality of spacers is placed between two sheets in the plurality of sheets and near the outer edge of each sheet. The plurality of sheets and plurality of spacers are arranged to form a stack of a plurality of cells comprising a plurality of chambers, each chamber being a volume that is at least partially enclosed by the two sheets and at least one spacer in the plurality of spacers. That is, a single spacer may be utilized to space apart the two sheets of a cell, or more than one spacer may be utilized. In embodiments with a third, intermediate electrode, the third electrode is inserted during assembly of the stack of plurality of cells. For example, the third electrode may be inserted within the stack, such as between two sheets, and may be inserted, for example, halfway between the first outer sheet 130 and second outer sheet 100.

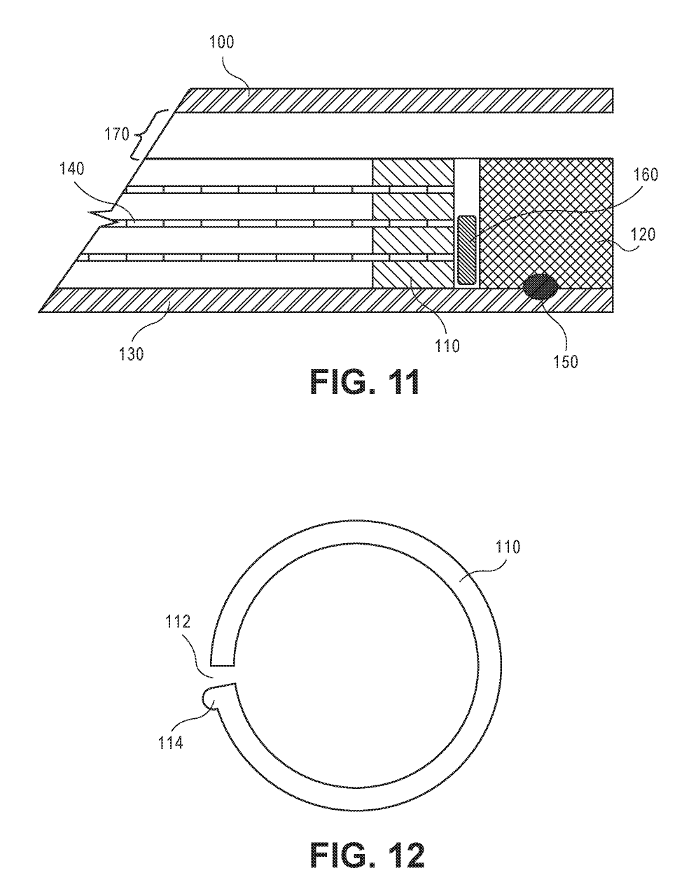

In embodiments that utilize frame 120, the frame is between the first outer sheet and the second outer sheet and surrounds the plurality of interior sheets and the plurality of spacers. In some embodiments, an optional gas getter is added to increase the purity of the working gas. The gas getter may be inserted by, for example, being coated onto some surfaces of the chamber, or may be inserted (e.g., gas getter 160 in FIG. 11) in a customized shape or as is available from suppliers. The getter material will depend on the emission gas and its sensitivity to various contaminating gases, but generally O₂, N₂, H₂, H₂O and CO and CO₂ are the main target gases for capture. The stack in step 230 is completed by mounting top outer sheet 100 to the assembled layers of bottom outer sheet 130, frame 120 (optional), spacers 110 and sheets 140. A gap 170, shown in FIG. 11, is left between the top outer sheet 100 and the assembled stack so that the chambers may be filled with discharge gas. The gap 170 provides an inlet area for filling the chambers with gas and may have a gap distance of, for example 1 mm. FIG. 12 shows a top view of an embodiment of ring-shaped spacer 110, having an opening 112 to allow an effective gas fill. The enlarged end 114, shown as a rounded end in this embodiment, guarantees that the ring spacer 110 will not self-seal against frame 120.

The assembled stack is evacuated and heated to remove surface contamination. If required, the getter is activated, and in step 240 of FIG. 10 the plurality of chambers is infilled with the emission material to the desired pressure, such as Xe at 40 kPa, through the gap 170 between the outer sheet 100 and the rest of the stack. The gap 170 between top outer sheet 100 and assembled stack 130-120-140-110 is then closed, and in step 250 the top outer sheet 100 is sealed to the stack, thus sealing the lamp shut. The seal may be, for example, weld seam 150 that is created with the above-described laser welding process through a transparent window and in an environment of the working gas. The working gas is then ventilated from the welding station and the lamp is ready.

Step 260 involves coupling a first electrode to an outer surface of the first outer sheet and a second electrode to an outer surface of the second outer sheet. This metallization on top of the top outer sheet 100 and below the bottom outer sheet 130, to form the electrodes, may be performed before or after the assembly process steps 210-250. Depending on the type of electrode, the electrode may be deposited onto the outer sheet or may be an external piece (e.g., metal mesh or metal plate) that is attached to the outer sheet. Deposition processes can include, for example, evaporation, sputtering and screen printing, as well as anodic growth and electroless growth. Optionally, the method of flow chart 200 may also include step 270 of coupling a power supply, such as a sinusoidal power supply, to the electrodes.

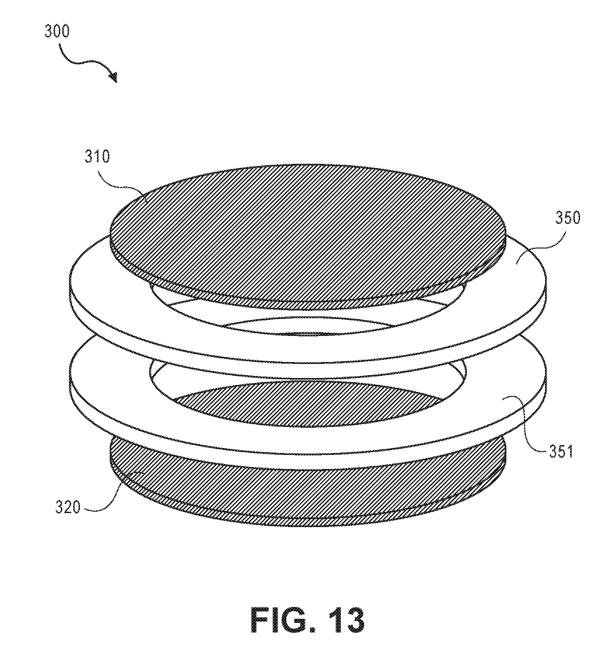

FIG. 13 illustrates another embodiment of assembling an excimer lamp 300 according to the present disclosure. An exploded view of a simplified lamp stack for excimer lamp 300 is shown, where the full stack of spacers and inner thin glass sheets are not shown for clarity. Top outer sheet 310 and bottom outer sheet 320 are made of sapphire, and the spacers 350 and 351 that are adjacent to the outer sheets 310 and 320, respectively, are made of glass that is CTE-matched to the sapphire to minimize strain during joining. In this perspective view, it can be seen that the spacers 350 and 351 are annular discs, where the central openings of the discs form the chambers in which plasma is to be generated. In assembly, top outer sheet 310 is joined with spacer 350, and bottom outer sheet 320 is joined to spacer 351. The joining is performed by, for example, glass frit or brazing to form a permanent hermetic metal seal. Then the full stack of interior glass sheets and spacers is inserted between the top assembly (310 with 350) and bottom assembly (320 with 351), and the entire stack is joined together, such as by laser welding. The chambers formed by the stack are filled with the desired discharge material, such as by laser welding in the appropriate atmosphere. Laser welding is amenable to automated manufacturing processes. In other embodiments, the assembly can be filled via a glass tube affixed to the assembly when the assembly is sealed by glass-frit or brazing. The glass tube is horizontally or vertically attached by glass frit or brazing, and the glass tube is sealed off after evacuating the assembly and filling with the appropriate gas.

Power Supply

The lamps of the present disclosure can be built with a power supply that is separate from or that is integrated on the backside of the lamp. In some embodiments, the power supply is a sinusoidal high voltage supply. Voltages between, for example, 1000-3000 V (peak-to-peak) per cell are suitable, as is a voltage of 7 kV or 8 kV (peak-to-peak) for the whole device. In some embodiments, the voltage may up to 25 kV, or other values of high voltages. The magnitude of the voltage depends upon the pressure and gap size, where pressure times diameter applies as scaling, and also depends on the gas in use and on the amount of over-biasing over the mere breakdown voltage. Also, ignition voltages often are higher than operating voltages. For example, a lamp may ignite at 8 kV but then be operated at 7.5 kV. Some lamps also become homogeneous only when the voltage is raised sufficiently above a minimum voltage. A specific design would allow all those factors to be considered and to operate the lamp with enough margin to compensate for process and manufacturing tolerances. Also the power supply itself may sense the state the lamp is in and regulate accordingly, such as a higher voltage before ignition, then lowering bias to predetermined bias or current.

The power supply driving the lamp is, for example, based on an oscillator, amplifier and step-up transformer. The inductance of the step-up transformer and the capacitance of the lamp form a resonant tank. The oscillator and amplifier is ideally operated at the resonance frequency to gain maximum output. An alternative to an inductive step-up transformer is a piezo electric step up transformer which may be used in a similar arrangement. A feedback loop measuring the lamp current and the step up voltage may be used to optimize operation automatically. The frequency of operation of the supply could be 50 kHz, 100 kHz, 120 kHz or other high frequency, such as ranging to 300 kHz.

While the specification has been described in detail with respect to specific embodiments of the invention, it will be appreciated that those skilled in the art, upon attaining an understanding of the foregoing, may readily conceive of alterations to, variations of, and equivalents to these embodiments. For example, different sets of islands could serve the charge seeding and charge removal purposes described above in the same DBD discharge volume. These and other modifications and variations to the present invention may be practiced by those skilled in the art, without departing from the scope of the present invention, which is more particularly set forth in the appended claims.

What is claimed is:

1. An excimer lamp comprising:
a plurality of sheets comprising a first outer sheet, a second outer sheet and a plurality of interior sheets, wherein each sheet in the plurality of sheets has an outer edge and comprises a material that is transmissive to a target wavelength;
a plurality of spacers, each spacer being placed between two sheets in the plurality of sheets and near the outer edge of each sheet, wherein the plurality of sheets and the plurality of spacers are arranged to form a stack of a plurality of cells including a plurality of chambers, each chamber being a volume at least partially enclosed by the two sheets and at least one spacer in the plurality of spacers;
an emission material within each chamber in the plurality of chambers;
a first electrode coupled to the first outer sheet, exterior to the stack; and
a second electrode coupled to the second outer sheet, exterior to the stack.

2. The excimer lamp of claim 1 wherein the target wavelength is in a range from 120 nm to 400 nm.

3. The excimer lamp of claim 1 further comprising a third electrode located within the stack.

4. The excimer lamp of claim 3 wherein the third electrode comprises a ring or a plate with apertures.

5. The excimer lamp of claim 3 wherein the third electrode is located halfway between the first outer sheet and the second outer sheet in the stack.

6. The excimer lamp of claim 1 further comprising a frame surrounding the plurality of interior sheets and the plurality of spacers.

7. The excimer lamp of claim 1 wherein each chamber in the plurality of chambers has a height of less than 1.0 mm.

8. The excimer lamp of claim 1 wherein each chamber in the plurality of chambers has a length-to-height aspect ratio of at least 10.

9. The excimer lamp of claim 1 wherein the plurality of chambers are in fluid communication with each other.

10. The excimer lamp of claim 1 further comprising a sinusoidal power supply electrically coupled to the first electrode and the second electrode.

11. A method of manufacturing an excimer lamp, the method comprising:
providing a plurality of sheets comprising a first outer sheet, a second outer sheet and a plurality of interior sheets, wherein each sheet in the plurality of sheets has an outer edge and comprises a material that is transmissive to a target wavelength;
sealing the first outer sheet to an adjacent lamp component;
stacking a plurality of spacers in an alternating arrangement with the plurality of sheets, wherein:
each spacer in the plurality of spacers is placed between two sheets in the plurality of sheets and near the outer edge of each sheet; and
the plurality of sheets and plurality of spacers are arranged to form a stack of a plurality of cells including a plurality of chambers, each chamber being a volume at least partially enclosed by the two sheets and at least one spacer in the plurality of spacers;
filling the plurality of chambers with an emission material;
sealing the second outer sheet to the stack;
coupling a first electrode to an outer surface of the first outer sheet; and
coupling a second electrode to an outer surface of the second outer sheet.

12. The method of claim 11 wherein the lamp component to which the first outer sheet is sealed is a frame, wherein the frame is between the first outer sheet and the second outer sheet and surrounds the plurality of interior sheets and the plurality of spacers.

13. The method of claim 11 further comprising coupling a sinusoidal power supply to the first electrode and the second electrode.
